(19) United States
(12) Patent Application Publication
(10) Pub. No.: US 2005/0170846 A1
(43) Pub. Date: Aug. 4, 2005

(54) AGPS system using a public radio paging network and a terminal position measurement method using the system

(75) Inventors: Ji-Youn Jeon, Seoul (KR); Jin-Won Kim, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/925,615

(22) Filed: Aug. 25, 2004

(30) Foreign Application Priority Data
Jan. 30, 2004 (KR) 6184/2004

(51) Int. Cl. H04Q 7/00

(52) U.S. Cl. 455/456.1

(57) ABSTRACT

An assisted global positioning system (AGPS) system capable of determining a position of a terminal more quickly and accurately by transceiving AGPS data utilizing a public radio paging network, which can transmit a large quantity of data at a very high speed. The present invention provides a mobile terminal with AGPS data through a public radio paging network, and the mobile terminal obtains a GPS signal more quickly by means of the AGPS data provided through the public radio paging network. Accordingly, the present invention reduces the time required for determining a terminal position using the GPS signal.

### PRIORITY

This application claims priority to an application entitled “AGPS System Using Public Radio Paging Network and Terminal Position Measurement Method Using the System” filed in the Korean Intellectual Property Office on Jan. 30, 2004 and assigned Serial No. 2004-6184, the contents of which are hereby incorporated by reference.

### BACKGROUND OF THE INVENTION

1. Field of the Invention

The present invention relates generally to an assisted global positioning system (AGPS), and more particularly to an AGPS system using a public radio paging network.

2. Description of the Related Art

Radio paging services have rapidly become very popular due to their high reception rates, small terminals having good mobility, and services with low prices. Accordingly, radio paging technology has gone from an initial analog method to a high speed paging method, and then rapidly developed into a two-way pager technology. Further, many radio paging carriers have constructed public radio paging networks in various places in order to provide radio paging services. Therefore, radio paging subscribers are able to receive radio paging services in most places. However, the radio paging technology as described above is not currently being used any differently from the time of its initial appearance.

FIG. 1 is a block diagram of a conventional public radio paging network. More specifically, FIG. 1 illustrates a two-way public radio paging network.

Referring to FIG. 1, a radio paging terminal 30, which is a two-way radio pager, receives a radio paging signal from the public radio paging network, and displays the received radio paging signal. When there is a radio paging request to another radio paging subscriber, the radio paging terminal 30 transmits a radio paging request signal for the request to the public radio paging network. The public radio paging network may include a radio paging base station 15 and a radio paging exchange 10.

The radio paging base station 15 receives the radio paging request signal for a predetermined radio paging subscriber to transmit the received signal to the radio paging exchange 10. The radio paging exchange 10 is connected to a plurality of common wired telephones through a public switched telephone network (PSTN).

When there is a radio paging request from a general wired telephone subscriber to a radio paging subscriber or from a radio paging subscriber to another radio paging subscriber, the radio paging exchange 10 generates a corresponding radio paging signal to transmit the generated signal to the radio paging base station 15. The radio paging base station 15 modulates the radio paging signal, which is transmitted from the radio paging exchange 10, into a radio signal, and transmits the modulated signal to the radio paging terminal 30 through an antenna.

Because the public radio paging network as described above transmits radio paging data using a digital link, it has a very high data transmission speed and can transmit large quantities of data. Further, because the public radio paging network includes a high speed response channel, it may be used in a two-way high speed data transmission service. However, the widely constructed public radio paging network is not that often, thereby often wasting of resources.

With the recent development of mobile communication technology, i.e., the development of various mobile communication terminals, such as cellular terminals, personal communication service (PCS) terminals, or personal digital assistant terminals, and of various services (e.g., voice communication, text transmission/reception, or voice mailbox) using the terminals, users have request a mobile communication service and also various supplementary service using position information. Because a mobile terminal can move together with a user and communicate in wireless manner, the user can receive various services using the position information through the mobile terminal.

Recent services using terminal position information provided by carriers may include traffic information services, map download services, position information services, weather information services, emergency services, or vehicle navigation services.

In order to provide the services using such terminal position information, a technology for determining terminal position is required and a system for terminal position determination must be constructed. However, in order to transmit and receive data with such a system for the position determination, a communication network for transmitting large quantities of data at a high speed is also required. Accordingly, when communication with a system for position determination can be performed by means of the underutilized two-way public radio paging network as described above, a waste of resources can be prevented and the underutilized two-way public radio paging network can be used more effectively.

### SUMMARY OF THE INVENTION

Accordingly, the present invention has been designed to solve the above and other problems occurring in the prior art, and an object of the present invention is to provide an AGPS system capable of determining a position of a terminal more quickly and accurately by transceiving AGPS data utilizing a public radio paging network which can transmit a large quantity of data at a very high speed.

In order to accomplish the above and other objects, according to one aspect of the present, there is provided an AGPS system comprising: a terminal apparatus for transmitting an AGPS data request signal, receiving a GPS signal utilizing AGPS data when the requested AGPS data is received, and measuring a position of the terminal apparatus utilizing the received GPS signal; a public radio paging network for transmitting AGPS data request information to a position determination entity when the AGPS data request signal is received from the terminal apparatus, and receiving the AGPS data corresponding to the AGPS data request information from the position determination entity to transmit the received AGPS data to the terminal apparatus; and the position determination entity for receiving the GPS signal and the AGPS data request information, generating the AGPS data corresponding to the position of the terminal apparatus by means of the received GPS signal and AGPS data request information, and providing the public radio paging network with the generated AGPS data.

According to another aspect of the present, there is provided a method for measuring a position of a terminal in an AGPS system using a public radio paging network, the method comprising the steps of: transmitting an AGPS data request signal required for measuring a position of a terminal apparatus; receiving the AGPS data request signal from the terminal apparatus; transmitting AGPS data request information to a position determination entity; receiving the AGPS data request information to generate corresponding AGPS data; transmitting the generated AGPS data to the public radio paging network; transmitting the AGPS data to the terminal apparatus; searching for an initial position of a GPS satellite by means of the GPS data; receiving a GPS signal; and measuring the position of the terminal apparatus by means of the received GPS signal.

### BRIEF DESCRIPTION OF THE DRAWINGS

The above and other objects, features, and advantages of the present invention will be more apparent from the following detailed description taken in conjunction with the accompanying drawings, in which:

FIG. 1 is a block diagram of a conventional public radio paging network;

FIG. 2 is a block diagram of an AGPS system using a public radio paging network according to an embodiment of the present invention;

FIG. 3 is a block diagram of a public radio paging network according to an embodiment of the present invention;

FIG. 4 is a block diagram of an AGPS terminal according to an embodiment of the present invention;

FIG. 5 is a view illustrating a format of data transmitted and received between a radio paging exchange and a position determination entity in an AGPS system using a public radio paging network according to an embodiment of the present invention; and

FIG. 6 is a flowchart illustrating the transmission of an AGPS message in an AGPS system using a public radio paging network according to an embodiment of the present invention.

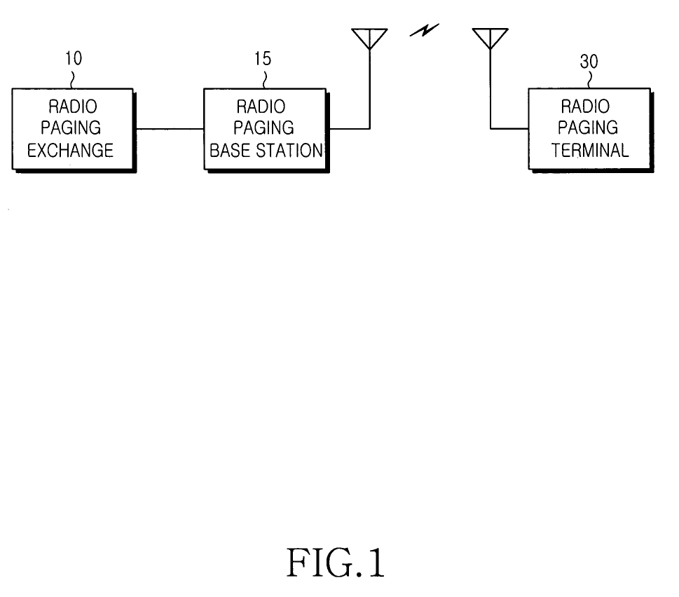

### DETAILED DESCRIPTION OF THE PREFERRED EMBODIMENT

Preferred embodiments of the present invention will be described in detail herein below with reference to the accompanying drawings. In the drawings, the same reference numerals are used to designate the same elements as those shown in other drawings.

In the below description, many particular items, such as detailed elements of circuit, are shown, but these are provided for helping the general understanding of the present invention. It will be understood by those skilled in the art that the present invention can be embodied without particular items. Additionally, in the following description of the present invention, a detailed description of known functions and configuration incorporated herein will be omitted when it may make the subject matter of the present invention rather unclear.

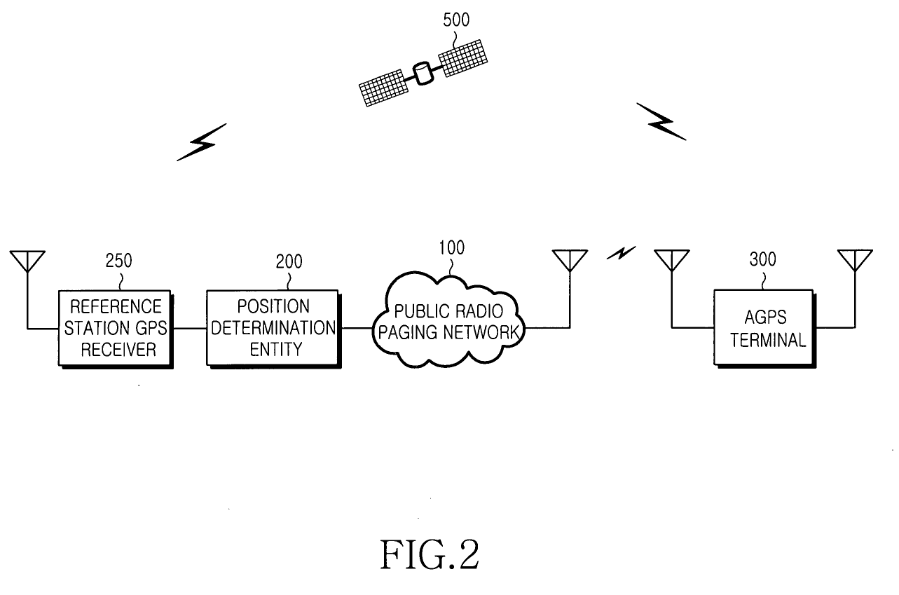

FIG. 2 is a block diagram of an AGPS system using a public radio paging network according to an embodiment of the present invention. Referring to FIG. 2, the AGPS system includes a public radio paging network 100, a position determination entity (PDE) 200, a GPS reference station receiver 250, an AGPS terminal 300, and a GPS satellite 500. The public radio paging network 100 transmits a synchronizing signal for synchronizing the AGPS terminal 300 to the public radio paging network 100 after predetermined time periods. The AGPS terminal 300, which includes a two-way radio paging terminal function, receives the synchronizing signal when it is powered on, and then maintains synchronization with the public radio paging network 100 by means of the synchronizing signal.

While maintaining synchronization with the public radio paging network 100, the AGPS terminal 300 generates AGPS data request information for requesting AGPS data related to its own position and sends the generated AGPS data request information to the position determination entity 200 through the public radio paging network 100. Herein, the AGPS data request information includes general position information of an AGPS terminal. Further, the AGPS terminal 300 determines the general position information of the AGPS terminal 300 by using a position of a radio paging base station or through a region carrier managing a public radio paging network.

The position determination entity 200 receives a GPS signal from the reference station GPS receiver 250 and receives the AGPS data request information from the public radio paging network 100. The position determination entity 200 analyzes the general position information of the AGPS terminal contained in the AGPS data request information by means of the GPS signal and the AGPS data request information, and generates AGPS data corresponding to the general position. For example, the position determination entity 200 generates AGPS data including ephemeris of the GPS satellite 500, current GPS time information, GPS traveling information, and GPS satellite information, which can be observed from the general position of the AGPS terminal 300. Because a more detailed description for the AGPS data generated by the position determination entity 200 is written in an IS-801 TIA/EIA(2001.2) specification, a detailed description will not be given herein.

The position determination entity 200 generates the AGPS data as described above and then transmits the generated AGPS data to the public radio paging network 100. The public radio paging network 100 transmits the AGPS data, which was sent from the position determination entity 200, to the AGPS terminal 300.

The AGPS terminal 300, which includes a GPS receiver, receives the GPS signal from the GPS satellite 500, and receives the AGPS data generated by the position determination entity 200 through the public radio paging network 100. The AGPS terminal 300 receives the GPS signal from the GPS satellite 500 more quickly and accurately by means of the AGPS data, and measures its own initial position by means of the received GPS signal.

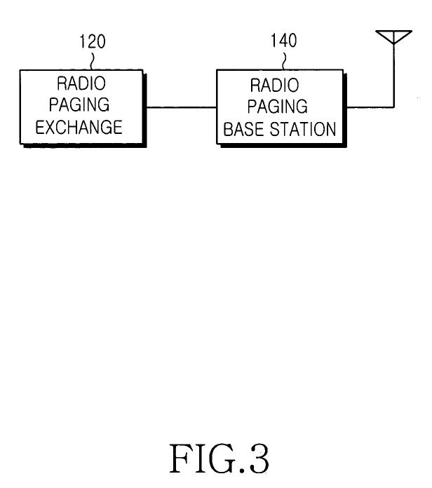

FIG. 3 is a block diagram of the public radio paging network 100 according to an embodiment of the present invention. Referring to FIG. 3, the public radio paging network 100 includes a radio paging exchange 120 and a radio paging base station 140. The radio paging base station 140 transmits the synchronizing signal for allowing the AGPS terminal 300 to be synchronized with the public radio paging network 100 after predetermined time periods, and receives the AGPS data request information signal from the AGPS terminal 300 to transmit the received signal to the radio paging exchange 120. The radio paging exchange 120 is connected to the position determination entity 200, and transmits the AGPS data request information transmitted through the radio paging base station 140 to the position determination entity 200. Further, the radio paging exchange 120 receives the AGPS data responding to the AGPS data request information from the position determination entity 200, to transmit the received AGPS data to the radio paging base station 140.

The radio paging base station 140 modulates the AGPS data transmitted from the radio paging exchange 120 into a radio signal to transmit the modulated signal to the AGPS terminal 300 through an antenna.

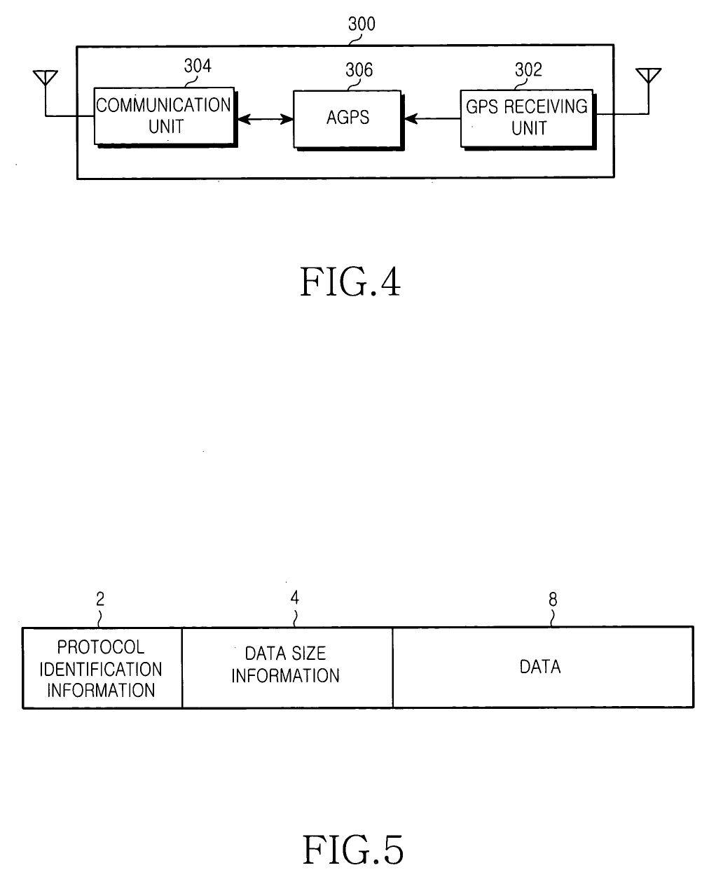

FIG. 4 is a block diagram of the AGPS terminal 300 according to an embodiment of the present invention. Referring to FIG. 4, the AGPS terminal 300 includes a GPS receiving unit 302, a communication unit 304, and an AGPS unit 306. The GPS receiving unit 302 receives the GPS signal from the GPS satellite 500. The communication unit 304 receives the synchronizing signal transmitted after predetermined time periods from the radio paging base station 140, and analyzes the received synchronizing signal to maintain synchronization with a radio paging system. Then, the communication unit 304 receives the AGPS data from the radio paging base station 140, to transmit the received AGPS data to the AGPS unit 306.

The AGPS unit 306 performs a general control operation of the AGPS terminal 300 according to the embodiment of the present invention. The AGPS unit 306 controls the GPS receiving unit 302 to receive the GPS signal more accurately from the GPS satellite 500 by means of the AGPS data received in the communication unit 304, and determines a position of the AGPS terminal 300 quickly and accurately by means of the GPS signal received in the GPS receiving unit 302.

Further, the AGPS unit 306 performs a control required for requesting the AGPS data to the position determination entity 200 through the public radio paging network 100, searches for a GPS initial position by means of the provided AGPS data, and calculates the current position of the AGPS terminal 300 by means of the GPS signal.

As is described above, the AGPS terminal 300 reduces a GPS initial position search time by using the AGPS data received from the position determination entity 200 through the public radio paging network 100. Therefore, the AGPS terminal 300 can quickly calculate its own current position.

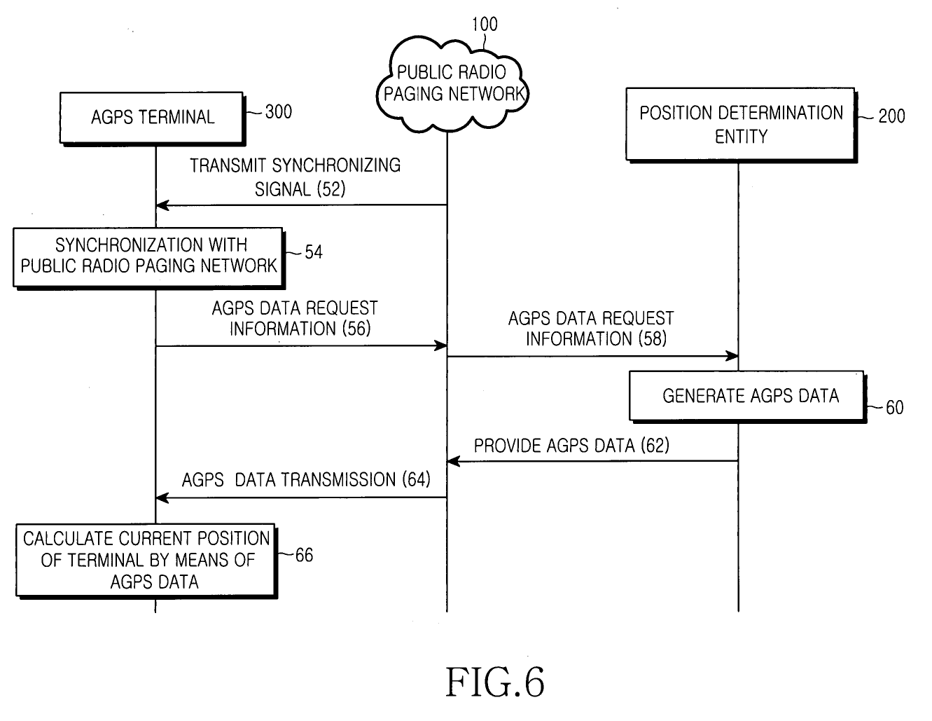

FIG. 5 is a view illustrating a format of data transmitted and received between the public radio paging network 100 and the position determination entity 200 in the AGPS system using the public radio paging network 100 according to an embodiment of the present invention. FIG. 6 is a flowchart illustrating a flow of a call process in the AGPS system using the public radio paging network 100 according to an embodiment of the present invention.

Referring to FIG. 5, the data transmitted/received among the AGPS terminal 300 and the public radio paging network 100 and the position determination entity 200 in the AGPS system using the public radio paging network 100 contains protocol identification information 2, data size information 4, and data 8. The protocol identification information 2 is protocol information promised in advance, which is used to transmit predetermined data from the AGPS terminal 300 to the position determination entity 200 through the public radio paging network 100, or from the position determination entity 200 to the AGPS terminal 300 through the public radio paging network 100. The data size information 4 is size information of data, which is to be transmitted from the AGPS terminal 300 to the position determination entity 200 through the public radio paging network 100, or from the position determination entity 200 to the AGPS terminal 300 through the public radio paging network 100. The data 8 is actual data, which is to be transmitted from the AGPS terminal 300 to the position determination entity 200 through the public radio paging network 100, or from the position determination entity 200 to the AGPS terminal 300 through the public radio paging network 100.

Referring to FIG. 6, an AGPS message processing stage in the AGPS system using the public radio paging network 100 according to the embodiment of the present invention will be described in detail herein below.

In step 52, the public radio paging network 100 transmits the synchronizing signal for synchronizing the AGPS terminal 300 to the public radio paging network 100, after a predetermined time period. For example, the radio paging base station 140 in the public radio paging network 100 transmits the synchronizing signal in order to synchronize the AGPS terminal 300 to the public radio paging network 100, after a predetermined time period.

When the synchronizing signal of the radio paging base station 140 is received, the AGPS terminal 300 analyzes the received synchronizing signal to synchronize with the public radio paging network 100 in step 54. When the synchronization with the public radio paging network 100 has been performed as described above, the AGPS terminal 300 transmits the AGPS data request signal required for determining its own position to the public radio paging network 100 in step 56.

When the AGPS data request signal is received from the AGPS terminal 300, the public radio paging network 100 transmits the AGPS data request information to the position determination entity 200 in step 58. Herein, the AGPS data request information is information for requesting the AGPS data related to the position of the AGPS terminal 300 and may include protocol identification information reporting a request of the AGPS data, size information of AGPS request data, and data.

The protocol identification information is protocol information promised in advance among the AGPS terminal 300 and the public radio paging network 100 and the position determination entity 200. The data size information is size information of data, which is to be transmitted from the AGPS terminal 300 to the position determination entity 200. The data is data for terminal position information, which is to be transmitted from the AGPS terminal 300 to the position determination entity 200.

In step 60, the position determination entity 200 generates the AGPS data related to the position of the AGPS terminal 300 using the AGPS data request information transmitted from the public radio paging network 100. Herein, the AGPS data contain data for AGPS information such as ephemeris of the GPS satellite 500, current GPS time information, GPS traveling information, and general position information of the AGPS terminal.

After the position determination entity 200 generates the AGPS data as described above, in step 62, the position determination entity 200 transmits the generated AGPS data to the public radio paging network 100. For example, the position determination entity 200 transmits the AGPS data, which contain protocol identification information for a response to the AGPS data request, size information of the AGPS data, and data for the AGPS information, to the radio paging exchange 120 in the public radio paging network 100.

In step 64, the public radio paging network 100 transmits the AGPS data, which is sent from the position determination entity 200, to the AGPS terminal 300 through the radio paging base station 140. In step 66, the GPS terminal 300, which can transmit/receive data to/from the public radio paging network 100, receives corresponding AGPS data from the radio paging base station 140, searches for the GPS initial position quickly and accurately, and calculates its own current position.

As is described above, an AGPS system according to the present invention provides a mobile terminal with AGPS data through a public radio paging network, and the mobile terminal can obtain a GPS signal more quickly by means of the AGPS data provided through the public radio paging network. Accordingly, the present invention reduces the time required for determining a terminal position using the GPS signal.

Further, an AGPS system according to the present invention considerably reduces construction costs of a wireless network for the AGPS system by using a public radio paging network, which is not often used, although it can transceive large quantities of radio data at a high speed. Furthermore, the AGPS system using the public radio paging network of the present invention transceives data using a simple data format, thereby reducing the service charge.

Although preferred embodiments of the present invention have been described for illustrative purposes, those skilled in the art will appreciate that various modifications, additions, and substitutions are possible, without departing from the scope and spirit of the present invention as disclosed in the accompanying claims, including the full scope of equivalents thereof.

1. An assisted global positioning system (AGPS) system comprising:
a terminal apparatus for transmitting an AGPS data request signal, receiving a GPS signal using AGPS data when the requested AGPS data is received, and measuring a position of the terminal apparatus using the received GPS signal;
a public radio paging network for transmitting AGPS data request information when the AGPS data request signal is received from the terminal apparatus, and receiving the AGPS data corresponding to the AGPS data request information, to transmit the received AGPS data to the terminal apparatus; and
a position determination entity for receiving the GPS signal and the AGPS data request information, generating the AGPS data corresponding to the position of the terminal apparatus using the received GPS signal and the received AGPS data request information, and providing the public radio paging network with the generated AGPS data.

2. The AGPS system as claimed in claim 1, wherein the AGPS data request information includes protocol identification information for requesting the AGPS data, size information of the AGPS data request information, and position information of the terminal apparatus.

3. The AGPS system as claimed in claim 1, wherein the AGPS data includes protocol identification information for a response to the AGPS data request, data size information for AGPS information, and data for the AGPS information.

4. The AGPS system as claimed in claim 3, wherein the data for the AGPS information includes at least one of ephemeris of a GPS satellite, time information of the GPS satellite, traveling information of the GPS satellite, and initial position information of the terminal apparatus.

5. The AGPS system as claimed in claim 1, wherein the terminal apparatus comprises:
a GPS receiving unit for receiving the GPS signal from the GPS satellite;
a communication unit for receiving the AGPS data; and
an AGPS unit for searching for an initial position of the GPS satellite using the AGPS data, and measuring the current position of the terminal apparatus using the GPS signal.

6. A method for measuring a position of a terminal in an assisted global positioning system (AGPS) system using a public radio paging network, the method comprising the steps of:
broadcasting, from a terminal apparatus, an AGPS data request signal for measuring a position of the terminal apparatus;
receiving, by the public radio paging network, the AGPS data request signal from the terminal apparatus;
transmitting AGPS data request information from the public radio paging network to a position determination entity;
receiving, by the position determination entity, the AGPS data request information;
generating corresponding AGPS data;
transmitting the generated AGPS data from the position determination entity to the public radio paging network;
transmitting the AGPS data from the public radio paging network to the terminal apparatus;
receiving the AGPS data the terminal apparatus;
searching for an initial position of a GPS satellite using the AGPS data;
receiving a GPS signal; and
measuring the position of the terminal apparatus using the received GPS signal.

7. The AGPS method as claimed in claim 6, wherein the AGPS data request information includes protocol identification information for requesting the AGPS data, size information of the AGPS data request information, and data for position information of the terminal apparatus.

8. The AGPS method as claimed in claim 6, wherein the AGPS data includes protocol identification information for a response to the AGPS data request, data size information for AGPS information, and data for the AGPS information.

9. The AGPS method as claimed in claim 8, wherein the data for the AGPS information includes at least one of ephemeris of a GPS satellite, time information of the GPS satellite, traveling information of the GPS satellite, and initial position information of the terminal apparatus.
